(19) United States
(12) Patent Application Publication
(10) Pub. No.: US 2015/0138964 A1
(43) Pub. Date: May 21, 2015

(54) METHOD OF MANAGING POLICY FOR REDUCING NETWORK LOAD IN OVERLOADED AREA, SYSTEM AND RECORDING MEDIUM THEREOF

(71) Applicant: IDEAWARE INC., Seongnam-si, Gyeonggi-do (KR)

(72) Inventor: Yang Meong Cha, Seongnam-si (KR)

(73) Assignee: IDEAWARE INC., Seongnam-si, Gyeonggi-do (KR)

(21) Appl. No.: 14/397,152

(22) PCT Filed: Jun. 11, 2013
(86) PCT No.: PCT/KR2013/005119

§ 371 Date: Oct. 24, 2014

(30) Foreign Application Priority Data
Jun. 14, 2012 (KR) 10 2012 0063501
Jun. 14, 2012 (KR) 10-2012-0063503
Jun. 14, 2012 (KR) 10-2012-0063504

(51) Int. Cl. H04W 28/02

(52) U.S. Cl. CPC H04W 28/0289
USPC 370/230

(57) ABSTRACT

The present invention relates to a method of managing a policy for reducing a network load in an overloaded area, a system and a recording medium thereof. The system includes a storage medium for storing identification information of a wireless terminal in connection with identification information of a policy agent installed in the wireless terminal, a communication section for receiving identification information of the wireless terminal positioned in an overloaded area at a specific time slot from a server over a communication network, a checking section for checking the identification information of the policy agent corresponding to the received identification information of the wireless terminal through the storage medium, and a processing section for transmitting policy information for blocking network usage to the policy agent corresponding to the checked identification information of the policy agent.

### BACKGROUND OF THE INVENTION

1. Technical Field

The present invention is to reduce wireless network load in an overloaded area at a specific time slot, by autonomously blocking network connection of the applications for wireless terminal located in the overloaded area at the specific time slot.

2. Description of the Related Art

After supplying smart-phones, patterns using a wireless terminal for individuals are abruptly changed from voice communication to data communication.

In FIG. 1 shown as mobile (wireless) data traffic index, mobile traffics are expected to increase to 26 times in the next 10 to 15 years, and mobile data amount of 15 MB used by individuals per day has been used in 2010 but mobile data amount of 1 GB will be used in 2020.

The increase of the mobile traffics directly effects on profitability and service quality of the mobile-service company and accompanies a service provider, that is, a mobile-service company's equipment expansion, and therefore profit aggravation is inevitable and a user using a mobile network has service dissatisfaction due to data communication velocity delay.

Therefore, the mobile-service company must effectively use network infra to reduce investment burden and to guarantee service quality and an alternative guaranteeing predictability and real-time control is needed due to the limits of current solutions.

Meanwhile, as FIG. 2 shows, mobile network congestions are mainly caused by unnecessary use of network by the applications installed in wireless terminal devices, numerous wireless terminal devices concentrated in a limited space (e.g. stadium, subway, etc.), and using patterns of users.

Data communication is delayed according to rapid increase of network availability for a specific area in the case that a number of the wireless terminal are driven to the defined areas such as stadiums, subways, etc. Therefore, there is a problem in that the applications disposed at the wireless terminal further increase network traffic while continuously performing network connection for data communication connection on a second basis.

In order to solve much cost consumption of the mobile communication company due to network jam and service dissatisfaction for users of the wireless terminal, a method for controlling the network connection by a plurality of applications disposed at the wireless terminal is absolutely needed, but there are no solutions for this.

### SUMMARY OF THE INVENTION

An object of the present invention for solving the above-mentioned problems is that it provides a method, a system and a recoding medium for smoothly controlling and adjusting a network usage in an overloaded area at a specific time slot, and improving data communication environment of the user and reducing battery consumption by network jam removal while reducing network expansion cost of a mobile communication company and improving service quality. To achieve this, a policy server processes so that policy information for blocking network usage is transmitted to a policy agent installed in a wireless terminal positioned in the overloaded area at the specific time slot. And, the policy server processes so that policy information for releasing the network usage blocking is transmitted to the policy agent, in case of receiving identification information of the wireless terminal deviated from the specific time slot or the overloaded area, or positioned in an overload-released area, where the network overload is released.

Technical tasks to achieve in the present invention are not limited to the above-mentioned technical tasks. Other technical tasks which are not mentioned may be clearly understandable for those who skilled in the art of the present invention from the following description.

A system of managing a policy for reducing a network load in an overloaded area according to the present invention, comprising: a storage medium for storing identification information of a wireless terminal in connection with identification information of a policy agent installed in the wireless terminal; a communication section for receiving identification information of the wireless terminal positioned in an overloaded area at a specific time slot from a server over a communication network; a checking section for checking the identification information of the policy agent corresponding to the received identification information of the wireless terminal through the storage medium; and a processing section for transmitting policy information for blocking network usage to the policy agent corresponding to the checked identification information of the policy agent.

According to an aspect of the present invention, the communication section further receives identification information of the wireless terminal deviated from the specific time slot or the overloaded area, or positioned in an overload-released area, where the network overload is released, from the server over the communication network, the checking section further checks the identification information of the policy agent installed in the wireless terminal in response to the received identification information of the wireless terminal through the storage medium, and the processing section further transmits policy information for releasing the network usage blocking to the policy agent corresponding to the checked identification information of the policy agent.

According to another aspect of the present invention, the processing section transmits identification information of one or more applications allowed the network usage irrespective of the position within the overloaded area at the specific time slot to the policy agent.

A method of managing a policy for reducing a network load in an overloaded area according to the present invention, comprising: checking, in a policy server, identification information of a policy agent installed in a wireless terminal in response to identification information of the wireless terminal through a storage medium storing the identification information of the wireless terminal in connection with the identification information of the policy agent installed in the wireless terminal; transmitting, in the policy server, policy information for blocking network usage to the policy agent corresponding to the checked identification information of the policy agent; and transmitting, in the policy server, policy information for releasing the network usage blocking to the policy agent, in case of receiving identification information of the wireless terminal deviated from the specific time slot or the overloaded area, or positioned in an overload-released area, where the network overload is released, from the server over the communication network.

According to an aspect of the present invention, the method of managing a policy for reducing a network load in an overloaded area, further comprising: transmitting identification information of one or more applications allowed the network usage irrespective of the position within the overloaded area at the specific time slot to the policy agent.

Also, the present invention includes a computer-readable recording medium for recording programs to perform each of the steps.

And, according to the present invention, the policy information for blocking the network usage is the policy information for blocking network connection for all applications except pre-designated specific applications among a plurality of applications using networks in the wireless terminal in the overloaded area at the specific time slot.

According to an embodiment of the present invention, the present invention may block unnecessary network connection attempts itself performed by the applications installed in the wireless terminal that may not transmit and receive data even on attempting the network because of being positioned in an overloaded area.

According to another embodiment of the present invention, the present invention may block unnecessary network connection attempts itself performed by the applications installed in the wireless terminals concentrated in the overloaded area, thereby to solve problems of network overload and optimize network usage at wireless terminal stages.

According to further another embodiment of the present invention, mobile-service Company's network expansion cost may be minimized by optimizing the network usage.

According to further yet another embodiment of the present invention, on optimizing network usage, it is possible to minimize dissatisfaction for the wireless terminal's user caused by data communication delay, etc. and to greatly reduce battery consumption for the wireless terminal.

### BRIEF DESCRIPTION OF THE DRAWINGS

The following drawing drawings attached to the present specification illustrates an exemplary embodiment of the invention, and serves to further understand the technical idea of the invention along with a detailed description of the invention. Therefore, the invention is not limited to matters described in the drawings.

FIG. 1 shows a view illustrating a mobile (wireless) data traffic indexes.

FIG. 2 shows a view illustrating main factors causing network congestions of the conventional technology.

FIG. 3 shows a communication network or network connection according to an embodiment of the present invention.

FIG. 4 shows sub-configurations for a policy server according to the embodiment of the present invention.

FIG. 5 shows sub-configurations for a wireless terminal according to the embodiment of the present invention.

FIG. 6 shows a process of managing a policy for blocking a network usage in an overloaded area at a specific time slot according to the embodiment of the present invention.

FIG. 7 shows a process for blocking a network connection of the wireless terminal positioned in the overloaded area at a specific time slot according to the embodiment of the present invention.

FIG. 8 shows a process of managing a policy for releasing the network usage blocking in case of deviation from the specific time slot or releasing from the overloaded area according to the embodiment of the present invention.

FIG. 9 shows a process for releasing the network connection blocking for the wireless terminal in case of deviation from the specific time slot or the overload area, or releasing from the overload area according to the embodiment of the present invention.

FIG. 10 shows a process of releasing the network connection blocking for the wireless terminal deviated from the overloaded area according to another embodiment of the present invention.

FIG. 11 shows a process of releasing the network connection blocking for the wireless terminal in case of deviation from the specific time slot according to the other embodiment of the present invention.

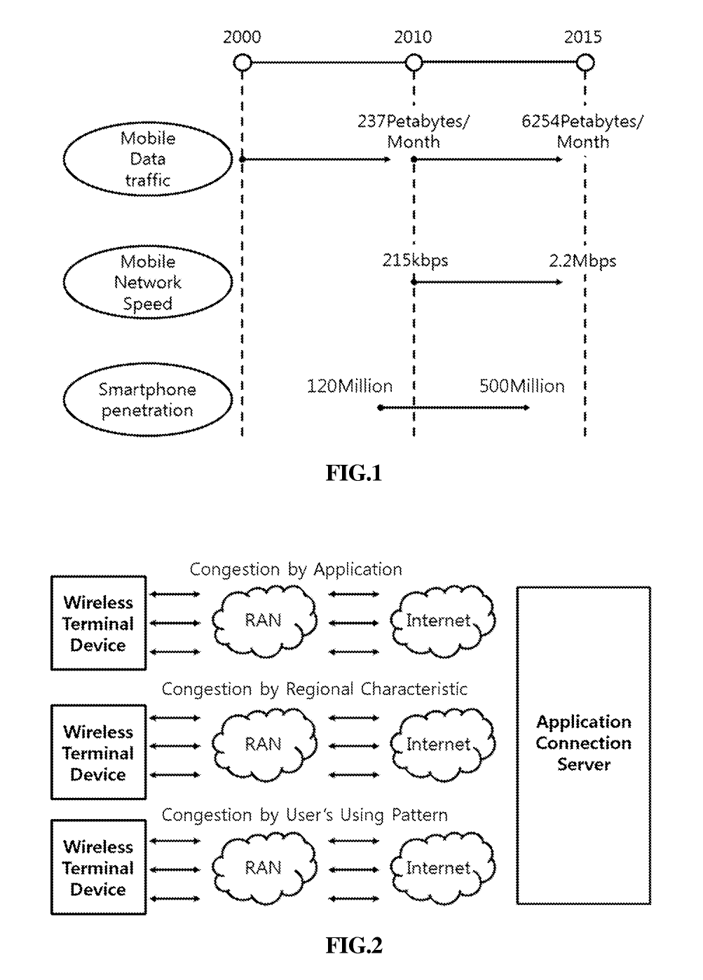

### DESCRIPTION OF THE PREFERRED EMBODIMENTS

Hereinabove, although the present invention is described by specific matters such as concrete components, and the like, embodiments, and drawings, they are provided only for assisting in the entire understanding of the present invention. The specified matters and embodiments and drawings such as specific apparatus drawings of the present invention have been disclosed for illustrative purposes, but are not limited thereto, and those skilled in the art will appreciate that various modifications, additions and substitutions are possible from the disclosure in the art to which the present invention belongs. In describing exemplary embodiments of the present invention, well-known functions or constructions will not be described in detail since they may unnecessarily obscure the understanding of the present invention. Further, the terminologies specifically defined in consideration of the configuration and functions of the present invention may be construed in different ways by the intention of users and operators. Therefore, the definitions thereof should be construed based on the contents throughout the specification. Therefore, the definitions thereof should be construed based on the contents throughout the specification.

It will be apparent to those skilled in the art that substitutions, modifications and variations can be made without departing from the spirit and scope of the invention as defined by the appended claims and can also belong to the scope of the invention.

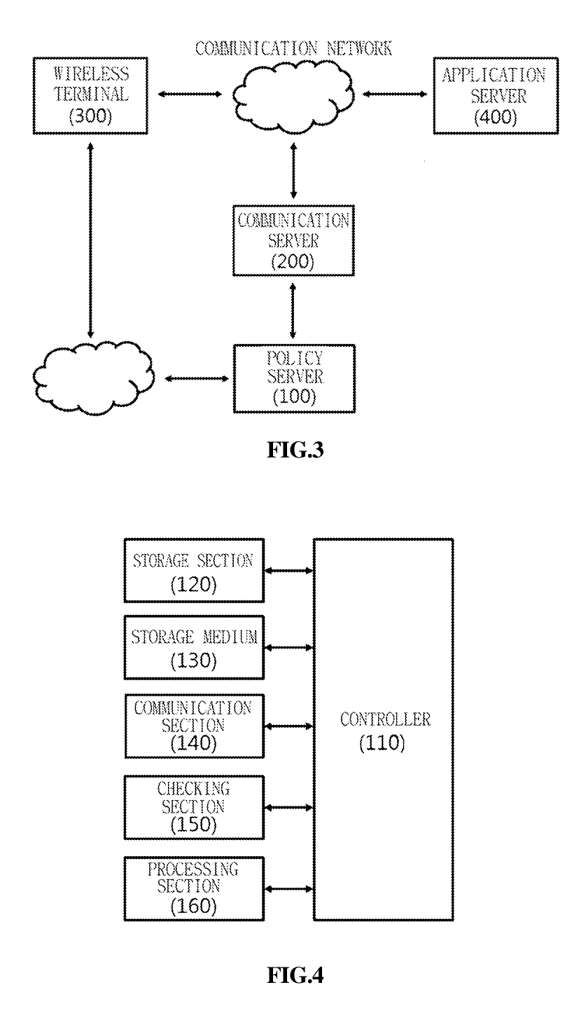

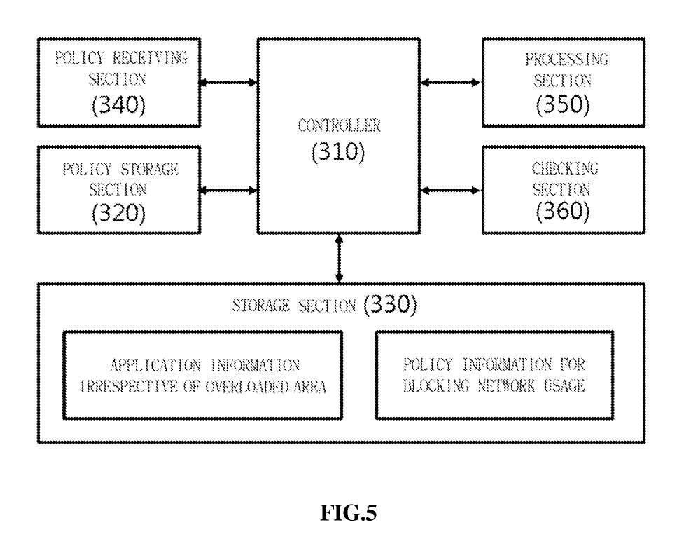

FIG. 3 shows a communication network or a network connection according to an embodiment of the present invention.

In more detail, FIG. 3 shows configurations that a system of managing a policy for reducing network load, the system including a policy server 100, are connected to a communication server 200 and a user's wireless terminal 300 through a communication network or a network to control network connection of applications for the wireless terminal 300 positioned in an overloaded area, where network overload occurs, at a specific time slot.

The system for managing the network load reduction policy, according to the present invention, may have various configurations according to implement method and connection method of the communication network.

For example, the policy server 100 may be connected to the communication server 200 through the communication networks or networks, or directly connected to the communication server 200, or included in the communication server 200.

The policy server 100, that is a core element of the system for managing network load reduction policy according to the present invention, receives identification information of the wireless terminal 300 positioned in the overloaded area at the specific time slot from the communication server 200 over the communication network. And, after checking identification information of a policy agent installed in the wireless terminal 300 in response to the identification information of the wireless terminal 300 positioned in the overloaded area at the specific time slot through a storage medium 130 that stores the identification information of the wireless terminal 300 and the identification information of the policy agent installed in the wireless terminal 300 connected with each other, the policy server 100 performs a role of processing so that policy information for blocking a network usage is transmitted to the policy agent corresponding to the checked identification information of the policy agent.

Here, the policy information for blocking the network usage includes the policy information for blocking network connection for all applications except pre-designated specific applications among a plurality of applications using networks in the wireless terminal 300 in the overloaded area at the specific time slot.

According to the present invention, the policy server 100 further receives identification information of the wireless terminal 300 deviated from the specific time slot or the overloaded area, or positioned in an overload-released area, where the network overload is released, from the communication server 200 over the communication network, and further checks the identification information of the policy agent installed in the wireless terminal 300 in response to the received identification information of the wireless terminal 300 through the storage medium 130. Afterward, the policy server 100 may transmit policy information for releasing the network usage blocking to the policy agent corresponding to the checked identification information of the policy agent. Also, the policy server 100 may transmit identification information of one or more applications allowed the network usage irrespective of the position within the overloaded area at the specific time slot to the policy agent.

The communication server 200 according to the embodiment of the present invention relays data communication between the wireless terminal 300 and an application server, checks whether the wireless terminal 300 is positioned in the overloaded area at the specific time slot, and transmits the identification information of the wireless terminal 300 positioned in the overloaded area at the specific time slot to the policy server 100, in case the wireless terminal 300 is positioned in the overloaded area.

Also, the communication server 200 checks deviations from the specific time slot or the overloaded area, or releasing from the overloaded area for the wireless terminal 300 positioned in the overloaded area. And, the communication server 200 further performs a role of transmitting the identification information of the wireless terminal 300 deviated from the time slot or the overloaded area, or positioned in the overload-released area to the policy server 100, in case of deviations from the specific time slot or the overloaded area, or releasing from the overloaded area.

The wireless terminal 300 according to the embodiment of the present invention, including the policy agent, performs the network connection to the application server, and therefore autonomously controls the network connection (or background call connection, etc.) of a plurality of applications installed in the wireless terminal 300 by using the policy information for blocking the network usage and the policy information for releasing the network usage blocking, the policy information being received from the policy server 100.

Further, the wireless terminal 300 in advance stores the identification information of the applications allowed the network usage irrespective of the position within the overloaded area at the specific time slot into a storage section. And, the wireless terminal 300 excludes the applications corresponding to the identification information pre-stored in the storage section among a plurality of applications using networks on performing the policy information received from the policy server 100 according to the position of the wireless terminal 300 in the overloaded area at the specific time slot.

Also, the wireless terminal 300, without communicating with the policy server 100, checks deviation from the overloaded area by checking information of the current position, and then releases the network connection blocking for the applications in case the current position corresponds to the position deviated from the overloaded area as a result of the checking. Or, the wireless terminal 300, without communicating with the policy server 100, checks deviation from the specific time slot by checking information of the current time, and then releases the network connection blocking for the applications in case the current position corresponds to the time deviated from the specific time slot as a result of the checking.

According to the present invention, the wireless terminal 300 include all terminal apparatuses, capable of wirelessly communicating, such as a mobile phone, a smart-phone, a tablet PC, etc.

The application server 400 according to the present invention transmits and receives data on performing the network connection for the applications installed in the wireless terminal 300.

FIG. 4 shows sub-configurations of the policy server 100 according to an embodiment of the present invention.

FIG. 4 shows sub-configurations of the policy server 100 in the system of managing the network load reduction policy, the system being shown in FIG. 3. And, each configuration of the policy server 100 are to describe an embodiment of the present invention, and the present invention is not limited to the embodiment only shown in FIG. 4.

Referring to FIG. 4, the policy server 100 in the embodiment of the present invention includes a storage section 120, a storage medium 130, a communication section 140, a checking section 150, a processing section 160, and a controller 110 for controlling each configuration.

Here, though the policy server 100 is shown as a single server in the drawing for a description of an example, may be composed of one or more separated servers for the each mean or component.

Referring to FIG. 4, the storage section 120 stores identification information of a plurality of wireless terminals 300 and identification information of the policy agents installed in each of the wireless terminals 300 into the storage medium 130, the identification information of the wireless terminal 300 and the identification information of the policy agent being connected to each other.

According to the present invention, the storage section 120 further stores various information and data that are transmitted and received with the communication server 200 and the user's wireless terminal 600 in the storage medium 130 or a database, besides the identification information of the wireless terminal 300 and the identification information of the policy agent.

Here, the identification information of the wireless terminal 300 may include at least one of a serial number of the wireless terminal 300 and identification information of a subscriber (or a user) of the wireless terminal 300, and the identification information of the policy agent may include unique ID or number of the agent.

The storage medium 130 according to the present invention stores and manages the identification information of a plurality of wireless terminals 300 in connection with the identification information of the policy agent in each of the wireless terminals 300.

According to the present invention, the storage medium 130 may be included in another server other than the policy server 100, or in the communication server 200.

The communication section 140 according to the present invention receives identification information of the wireless terminal 300 positioned in the overloaded area at the specific time slot, from the communication server 200 over the communication network.

Also, the communication section 140 transmits and receives various information and data with the communication server 200 and the user's wireless terminal 300.

For example, the communication section 140 may further receive identification information of the wireless terminal 300 deviated from the specific time slot or the overloaded area, or positioned in the overload-released area, from the communication server 200 over the communication network. And, the communication section 140 may transmit identification information of one or more applications allowed the network usage irrespective of the position within the overloaded area at the specific time slot to the policy agent included in the wireless terminal 300.

The checking section 150 according to an embodiment of the present invention checks the identification information of the policy agent corresponding to the identification information of the wireless terminal 300 positioned in the overloaded area at the specific time slot, the policy agent being installed in the wireless terminal 300, by using the storage medium 130.

According to the present invention, in case the communication section 140 receives the identification information of the wireless terminal 300 deviated from the specific time slot or the overloaded area, or positioned in the overload-released area from the communication server 200 over the communication network, the checking section 150 may further check the identification information of the policy agent corresponding to the received identification information of the wireless terminal by using the storage medium 130.

The processing section 160 according to the present invention processes so that the policy information for blocking network usage is transmitted to the policy agent corresponding to the identification information checked by the checking section 150.

Here, the policy information for blocking network usage includes policy information for blocking network connection of all applications except one or more predetermined applications among a plurality of applications installed in the wireless terminal 300 positioned in the overloaded area at the specific time slot.

Also, the processing section 160 processes so that the identification information of the application allowed the network usage irrespective of the position within the overloaded area at the specific time slot is transmitted to the policy agent. And, in case the wireless terminal 300 is deviated from the specific time slot or the overloaded area, or positioned in the overload-released area, the processing section 160 may further process so that policy information for releasing network usage blocking transmitted to the policy agent.

According to the present invention, a whole or a part of the functions of each component included in the policy server 100 may be implemented in a program or program set.

FIG. 5 shows sub-configurations of the wireless terminal 300 according to an embodiment of the present invention.

In more detail, FIG. 5 shows sub-configurations for the wireless terminal 300 shown in FIG. 3, each configuration is to describe an embodiment of the present invention, and the present invention is not limited to the embodiment only shown in FIG. 5.

Referring to FIG. 5, the wireless terminal 300 in the embodiment of the present invention includes a policy receiving section 340, a policy storage section 320, a policy storage section 330, a processing section 350, a checking section 360, and a controller 310 for controlling each configuration.

Wholly or in part of each configuration of the wireless terminal 300 may be configured in a program type such as policy agent.

Referring to FIG. 5, the policy receiving section 340 receives identification information of one or more applications allowed the network usage irrespective of the position within the overloaded area at the specific time slot, and receives various information such as the policy information, for blocking the network usage, and the policy information, for releasing the network usage blocking, from the policy server 100.

The policy storage section 320 according to the embodiment of the present invention stores the identification information of the applications allowed the network usage irrespective of the position in the overloaded area at the specific time slot, the identification information being received by the policy receiving section 340.

The policy storage section 320 according to the present invention stores the policy information for blocking the network usage and the policy information for releasing the network usage blocking, besides the identification information of the applications allowed the network usage irrespective of the position in the overloaded area at the specific time slot, into the storage section 330.

The storage section 330 according to the embodiment of the present invention stores and manages the identification information of the applications allowed the network usage irrespective of the position in the overloaded area at the specific time slot.

Further, the storage section 330 stores the policy information for blocking the network usage and the policy information for releasing the network usage blocking, besides the identification information of the applications allowed the network usage irrespective of the position in the overloaded area at the specific time slot.

The processing section 350 in the embodiment of the present invention blocks the network connection for all applications except the applications corresponding to the identification information of the applications allowed the network usage, pre-stored in the storage section 330, among the applications using network based on the policy information for blocking the network usage received by the policy receiving section 340.

Further, in case of receiving the policy information for releasing the network usage blocking from the policy server 100 over the communication network by using the policy receiving section 340, the processing section 350 releases the network connection blocking for the applications based on the received policy information for blocking the network usage blocking.

The checking section 360 according to the embodiment of the present invention checks the current position information and then checks whether the wireless terminal 300 is deviated from the overloaded area.

Also, the checking section 360 according to another embodiment of the present invention checks the current time information and then checks deviation from the specific time slot.

According to the present invention, the processing section 350 may release the network connection blocking for the applications installed in the wireless terminal 300, in case the current position corresponds to the position deviated from the overloaded area, according to the result checked by the checking section 360. And, the processing section 350 may release the network connection blocking for the applications installed in the wireless terminal 300, in case the current time corresponds to the time deviated from the specific time slot, according to the result checked by the checking section 360.

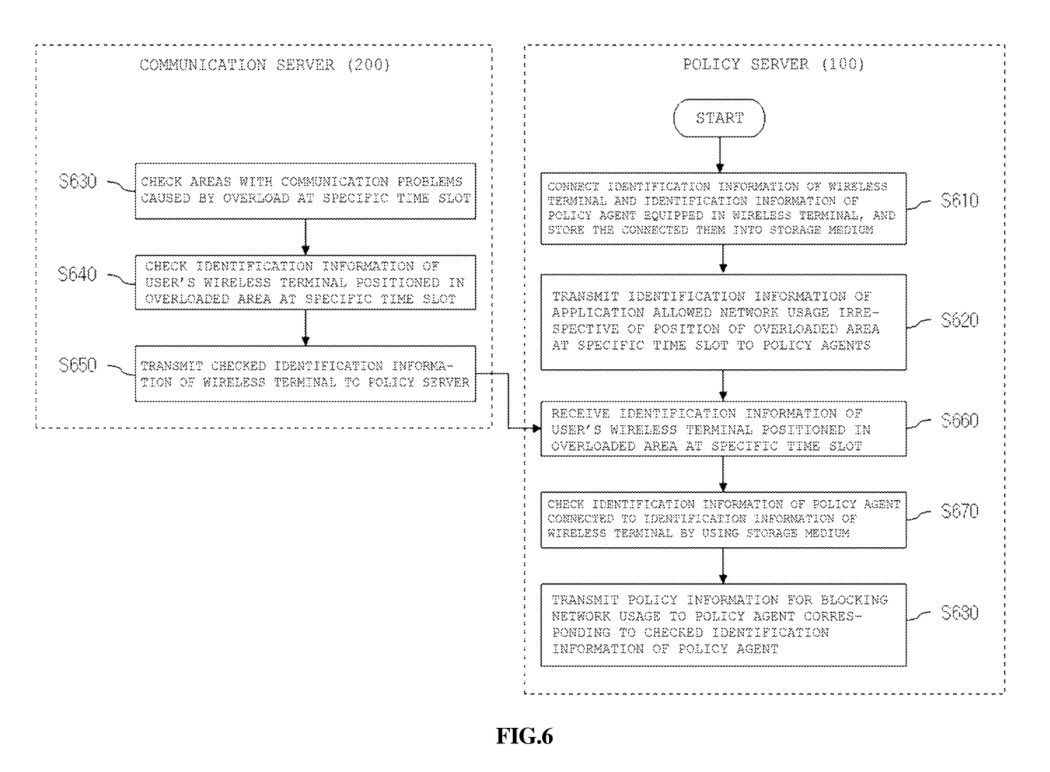

FIG. 6 shows a process for managing the network usage blocking policy in the overloaded area according to the embodiment of the present invention.

Firstly, the policy server 100 connects identification information of a plurality of wireless terminals 300 and identification information of the policy agents installed in the plurality of wireless terminals 300 and therefore stores the connected them into the storage medium 130, by using the storage section 120 (S610).

Then, the policy server 100 transmits identification information of one or more applications allowed the network usage irrespective of the position in the overloaded area at the specific time slot to the policy agents installed in the wireless terminal 300 by using the processing section 160, and the policy agent stores the identification information of the applications allowed the network usage irrespective of the position in the overloaded area at the specific time slot into the storage section (S620).

Orders for the steps S610 and S620 may be changed.

The communication server 200 according to the present invention checks areas generated with communication problems caused by overload at the specific time slot over the communication network (S630), and then checks identification information of the wireless terminals 300 positioned in the overloaded area at the specific time slot (S640).

The communication server 200 may check the position of the wireless terminal 300 using the wireless terminal 300 information connected to a base station and/or an exchange office at step S640.

When the position of the wireless terminal 300 and the current time corresponds to the overloaded area at the specific time slot in the step of S640, the communication server 200 transmits the identification information of the wireless terminal 300 positioned in the overloaded area at the specific time slot to the policy server 100 (S650).

The policy server 100 receives identification information of the wireless terminal 300 positioned in the overloaded area at the specific time slot, from the communication server 200 through the communication section 140 (S660).

The checking section 150 in the policy server 100 checks the identification information of the policy agent installed in the wireless terminal 300 in response to the received identification information of the wireless terminal 300 positioned in the overloaded area at the specific time slot by using the storage medium 130 (S670).

Afterward, the policy server 100 transmits the policy information for blocking the network usage to the policy agents corresponding to the identification information checked by the checking section 150 by using the processing section 160 (S680).

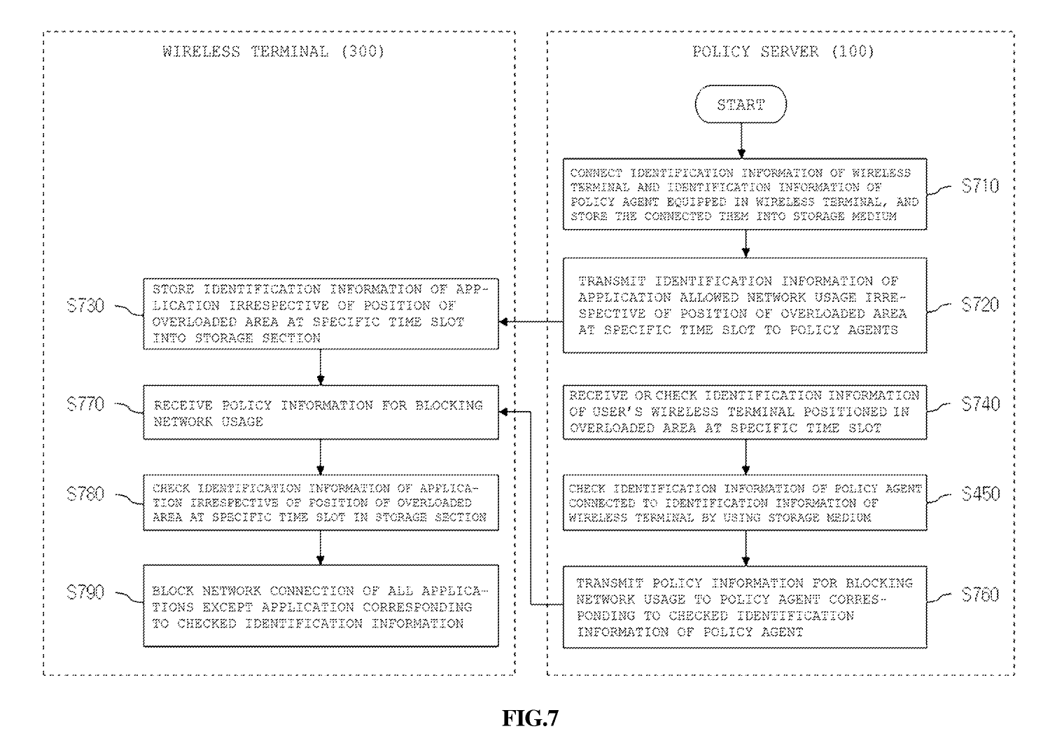

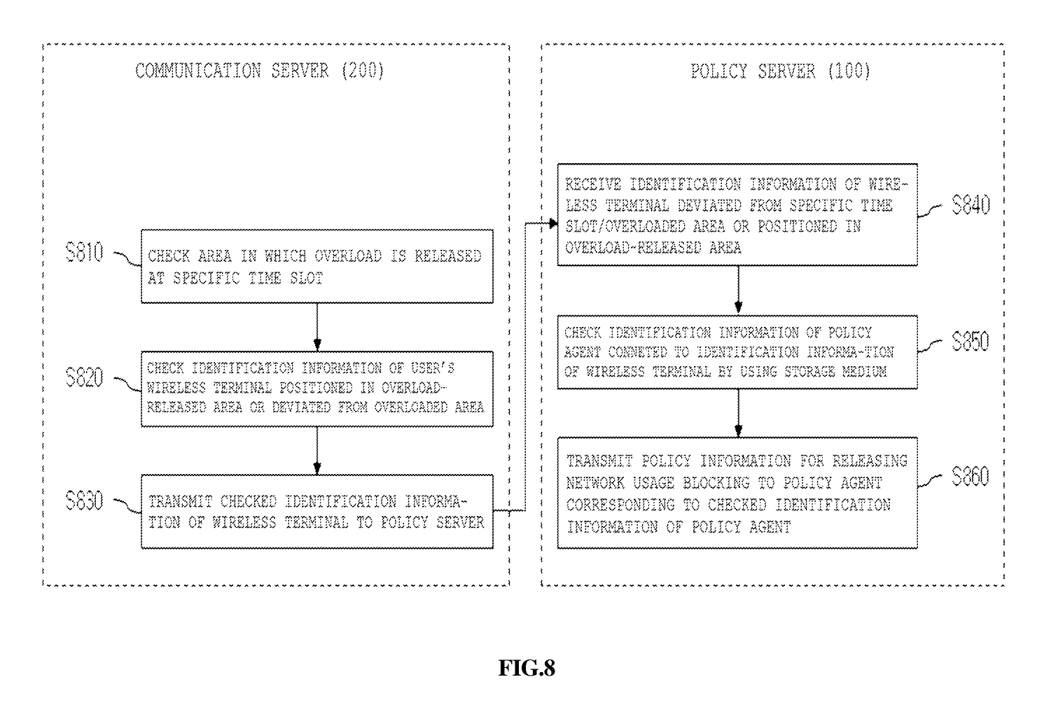

FIG. 7 shows a process of blocking the network connection for the wireless terminal positioned in the overloaded area at the specific time slot, according to the embodiment of the present invention.

Firstly, the policy server 100 connects identification information of a plurality of wireless terminals 300 and identification information of the policy agents installed in the plurality of wireless terminals 300 and therefore stores the connected them into the storage medium 130 (S710).

Then, the policy server 100 transmits identification information of one or more applications allowed the network usage irrespective of the position in the overloaded area at the specific time slot to the policy agents installed in the wireless terminal 300, and the policy agent stores the identification information of the applications allowed the network usage irrespective of the position in the overloaded area at the specific time slot into the storage section 330 (S720).

Orders for the steps S710 and S720 may be changed.

Here, the wireless terminal 300 receives the identification information of one or more applications allowed the network usage irrespective of the position in the overloaded area at the specific time slot, and stores the identification information received from the policy server 100 into the storage section 330 (S730).

Afterward, the policy server 100 receives identification information of the wireless terminal positioned in the overloaded area at the specific time slot from the communication server 200, or directly checks the identification information of the wireless terminal positioned in the overloaded area at the specific time slot (S740).

The policy server 100 or the communication server 200 may check the position of the wireless terminal 300 using the wireless terminal 300 information connected to a base station and/or an exchange office, in the step of S740.

The policy server 100 checks the identification information of the policy agent installed in the wireless terminal 300 in response to the received or checked identification information of the wireless terminal 300 positioned in the overloaded area at the specific time slot by using the storage medium (S750).

Afterward, the policy server 100 transmits the policy information for blocking the network usage to the policy agents corresponding to the checked identification information of the policy agent (S760).

The policy agent in the wireless terminal 300 receives the policy information for blocking the network usage from the policy server 100 (S770), and then checks one or more applications corresponding to the identification information pre-stored in the storage section 330 among the plurality of applications using the network (S780).

Then, the policy agent in the wireless terminal 300 blocks the network connection for all applications except the checked applications corresponding to the identification information pre-stored in the storage section 330 among the plurality of applications using the network, based on the received policy information for blocking the network usage (S790).

FIG. 8 shows a process of managing the policy for releasing the network usage blocking in the overload-released area, according to the embodiment of the present invention.

The communication server 200 according to the present invention checks deviation from the specific time slot or releasing from the overloaded area (S810), and checks identification information of the wireless terminal deviated from the specific time slot or the overloaded area, or positioned in the overload-released area (S820).

Then, the communication server 200 transmits the identification information of the wireless terminal deviated from the specific time slot or the overloaded area, or positioned in the overload-released area, the identification information being checked in the step of S820, to the policy server 100 (S830).

The policy server 100 receives the identification information of the wireless terminal deviated from the specific time slot or the overloaded area, or positioned in the overload-released area from the communication server 200 by using the communication section 140 (S840).

Afterward, the checking section 150 in the policy server 100 checks identification information of the policy agent installed in the wireless terminal 300 in response to the received identification information of the wireless terminal deviated from the specific time slot or the overloaded area, or positioned in the overload-released area by using the storage medium 130 (S850).

Then, the policy server 100 transmits the policy information for releasing the network usage blocking to the policy agent corresponding to the identification information checked by the checking section 150 by using the processing section 160 (S860).

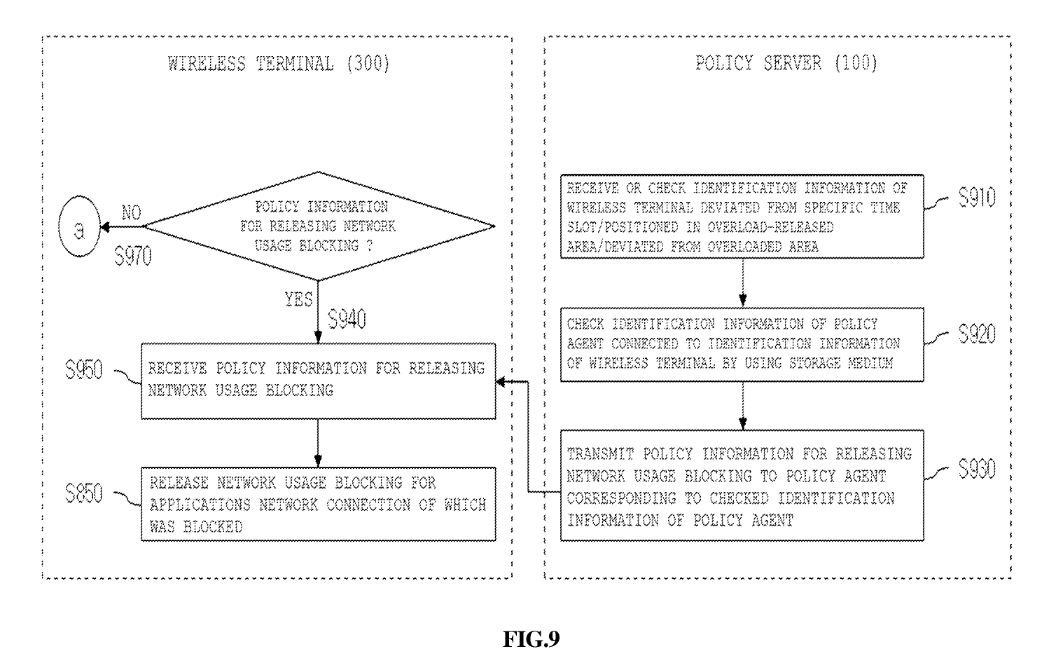

FIG. 9 shows a process of releasing the network connection blocking for the wireless terminal deviated from the specific time slot or the overloaded area, or positioned in the overload-released area, according to the embodiment of the present invention.

Firstly, the policy server 100 according to the present invention receives from the communication server or directly checks identification information of the wireless terminal 300 deviated from the specific time slot or the overloaded area, or positioned in the overload-released area (S910).

To check whether the wireless terminal 300 positioned in the overloaded area at the specific time slot is deviated or released from the overloaded area in the communication server 200 or the policy server 100 at step S910 may check the position of the wireless terminal 300 and whether it is deviated or released from the overloaded area, using information of the wireless terminal 300 connected to the base station and/or the exchange office.

Then, the policy server 100 checks the identification information of the policy agent installed in the wireless terminal 300 in response to identification information of the wireless terminal 300 deviated from the specific time slot or the overloaded area, or positioned in the overload-released area by using the storage medium (S920).

The policy server 100 transmits the policy information for releasing the network usage blocking to the policy agent corresponding to the checked identification information by using the processing section 160 (S930).

Afterward, in case of releasing the network usage blocking based on the policy information for releasing the network usage blocking (S950), the policy agent installed in the wireless terminal 300 receives the policy information for releasing the network usage blocking transmitted from the policy server 100 (S960) and then releases the network connection blocking for the applications based on the received policy information for releasing the network usage blocking (S960).

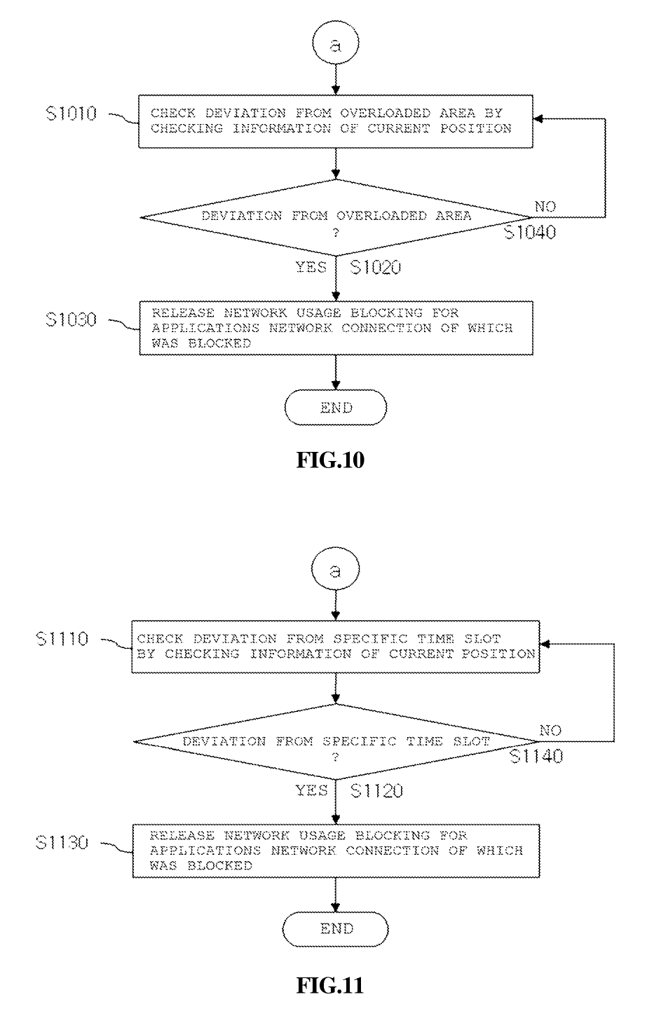

A process for the case of autonomously determining releasing of the network usage blocking without the policy information for releasing the network usage blocking (S970) is described in FIGS. 10 and 11.

FIG. 10 shows a process of releasing the network connection blocking for the wireless terminal deviated from the overloaded area at the specific time slot, according to another embodiment of the present invention.

In case of autonomously determining releasing of the network usage blocking without the policy information for releasing the network usage blocking, the policy agent in the wireless terminal 300 checks the current position information of the wireless terminal 300 using GPS information or the base station information (S1010).

In case the current position information checked in the step of S1010 corresponds to the position deviated or released from the overloaded area (S1020), the policy agent of the wireless terminal 300 releases the network connection blocking for the applications for which the network connection was blocked according to the position within the overloaded area (S1030).

In case the current position information checked in the step of S1010 does not correspond to the position deviated or released from the overloaded area (S1040), the policy agent of the wireless terminal 300 repeats the step of S1010.

FIG. 11 shows a process of releasing the network connection blocking for the wireless terminal deviated from the specific time slot, according to the other embodiment of the present invention.

In case of autonomously determining releasing of the network usage blocking without the policy information for releasing the network usage blocking, the policy agent in the wireless terminal 300 checks deviation from the specific time slot by checking the current time information (S1110).

In case the current time information checked in the step of S1110 is deviated from the specific time slot (S1120), the policy agent of the wireless terminal 300 releases the network connection blocking for the applications for which the network connection was blocked according to the position within the overloaded area (S1130).

In case the current time information checked in the step of S1110 is included in the specific time slot (S1140), the policy agent of the wireless terminal 300 repeats the step of S1110.

In addition, the above-described present invention may be implemented as a program executable in a computer and may be stored in a computer-readable recording medium; examples of the computer-readable recording medium may be ROM, RAM, CD-ROM, Magnetic Tape, Floppy Disk, Optical Data Storage, etc., including carrier wave (e.g., transmission through internet).

The computer-readable recording medium may be distributed to a computer systems connected in a network, so that the computer-readable code may be stored and executed in a distributed mode. Also, functional program, code and code segments for implementing the controlling method may be inferred easily by programmers who skilled in the art of the present invention.

In the above, preferred embodiments of the present invention have been described. However, these embodiments are merely examples and do not limit the present invention, so that persons who skilled in the art of the present invention may easily transform and modify within the limit of the technical spirit of the present invention. For example, each of the components shown in detail in the embodiments of the present invention may be implemented in transformation. In addition, the differences relating these transformations and modifications shall be regarded to be included in the scope of the present invention as defined in the attached claims of the present invention.

1-17. (canceled)

18. A system of managing a policy for reducing a network load in an overloaded area, comprising:
a communication section for receiving identification information of a wireless terminal positioned in an area where overload occurs from a server over a communication network; and
a processing section for transmitting policy information for blocking network usage to the wireless terminal positioned in the overloaded area using the received identification information of the wireless terminal.

19. A system of managing a policy for reducing a network load in an overloaded area according to claim 18, wherein the communication section transmits identification information of one or more applications allowed the network usage irrespective of the position within the overloaded area to the wireless terminal.

20. A system of managing a policy for reducing a network load in an overloaded area according to claim 19, wherein the policy information for blocking the network usage is the policy information for blocking network connection of all applications except the applications allowed the network usage irrespective of the position within the overloaded area.

21. A system of managing a policy for reducing a network load in an overloaded area according to claim 18, wherein the policy information for blocking the network usage blocks attempt call for network connection of the applications installed in the wireless terminal positioned in the overloaded area.

22. A system of managing a policy for reducing a network load in an overloaded area according to claim 18, wherein the policy information for blocking the network usage blocks at least one of foreground connection and background connection of the applications installed in the wireless terminal positioned in the overloaded area.

23. A system of managing a policy for reducing a network load in an overloaded area according to claim 18, wherein the identification information of the wireless terminal includes subscriber information of the wireless terminal's user or identification information of the policy agent equipped in the wireless terminal.

24. A system of managing a policy for reducing a network load in an overloaded area according to claim 23, wherein the policy information for blocking the network usage is transmitted to the policy agent equipped in the wireless terminal, using the identification information of the policy agent.

25. A system of managing a policy for reducing a network load in an overloaded area according to claim 18, wherein the communication section receives identification information of the wireless terminal positioned in an area that is released from the overloaded area or deviated from the overloaded area, from the server.

26. A system of managing a policy for reducing a network load in an overloaded area according to claim 25, wherein the processing section transmits policy information for releasing the network usage blocking to the wireless terminal, using the identification information of the wireless terminal positioned in an area that is released from the overloaded area or deviated from the overloaded area.

27. A system of managing a policy for reducing a network load in an overloaded area according to claim 18, wherein the communication section receives identification information of the wireless terminal positioned in the overloaded area at a specific time slot from the server.

28. A method of managing a policy for reducing a network load in an overloaded area, comprising:
receiving identification information of a wireless terminal positioned in an area where overload occurs from a server over a communication network; and
transmitting policy information for blocking network usage to the wireless terminal positioned in the overloaded area using the received identification information of the wireless terminal.

29. A method of managing a policy for reducing a network load in an overloaded area according to claim 28, further comprising:
transmitting identification information of one or more applications allowed the network usage irrespective of the position within the overloaded area to the wireless terminal.

30. A method of managing a policy for reducing a network load in an overloaded area according to claim 29, wherein the policy information for blocking the network usage is the policy information for blocking network connection of all applications except the applications allowed the network usage irrespective of the position within the overloaded area.

31. A method of managing a policy for reducing a network load in an overloaded area according to claim 28, wherein the policy information for blocking the network usage blocks attempt call for network connection of the applications installed in the wireless terminal positioned in the overloaded area.

32. A method of managing a policy for reducing a network load in an overloaded area according to claim 28, wherein the policy information for blocking the network usage blocks at least one of foreground connection and background connection of the applications installed in the wireless terminal positioned in the overloaded area.

33. A method of managing a policy for reducing a network load in an overloaded area according to claim 28, wherein the identification information of the wireless terminal includes subscriber information of the wireless terminal's user or identification information of the policy agent equipped in the wireless terminal.

34. A method of managing a policy for reducing a network load in an overloaded area according to claim 28, further comprising:
receiving identification information of the wireless terminal positioned in an area that is released from the overloaded area or deviated from the overloaded area, from the server.

35. A method of managing a policy for reducing a network load in an overloaded area according to claim 34, further comprising:
transmitting policy information for releasing the network usage blocking to the wireless terminal, using the identification information of the wireless terminal positioned in an area that is released from the overloaded area or deviated from the overloaded area.

36. A method of managing a policy for reducing a network load in an overloaded area according to claim 28, wherein the receiving receives identification information of the wireless terminal positioned in the overloaded area at a specific time slot from the server.

37. A computer-readable recording medium for recording programs to perform a method of claim 28.
